(19) United States
(12) Patent Application Publication
(10) Pub. No.: US 2014/0357137 A1
(43) Pub. Date: Dec. 4, 2014

(54) CONTACT CAGE AND FEMALE CONTACT USING SAME

(71) Applicant: K. S. TERMINALS INC., CHANGHUA COUNTY (TW)

(72) Inventors: Sheng-Sian SIAN, Changhua County (TW); Tung-Yao KO, Changhua County (TW)

(73) Assignee: K. S. TERMINALS INC., CHANGHUA COUNTY (TW)

(21) Appl. No.: 13/969,661

(22) Filed: Aug. 19, 2013

(30) Foreign Application Priority Data
May 30, 2013 (TW) 102119153

(51) Int. Cl. H01R 13/11

(52) U.S. Cl. CPC H01R 13/111
USPC 439/843

(57) ABSTRACT

A contact cage includes a sheet member having a plurality of first elongated slots and a plurality of second elongated slots respectively linearly arranged on the sheet member. A protruding portion is respectively defined between each two adjacent first elongated slots and each two adjacent second elongated slots and it is bent to provide at least one end point. Thus, the contact cage can be rolled up in a configuration of a hollow cylinder and positioned within a female terminal, enabling the end points to provide a larger contact area and to prolong the service life of the female terminal.

### BACKGROUND OF THE INVENTION

1. Field of the Invention

The present invention relates to the technical field of electrically-conductive connection structures defined under IPC (International Patent Classification) H01R, and more particularly to a contact cage for use in electric conduction in a female terminal to provide a larger contact area for direct contact with an inserted male terminal to effectively distribute the heat created by the resistance of the contact cage during high current transmission, preventing the problems of electric disconnection or the damage of the terminal.

2. Description of the Related Art

Contact cage structure for use in a female terminal belong to prior art. One important application is in automotive industry. When an electric wire loads high current from an engine or a battery, if the contact area between a female terminal and its corresponding male terminal is insufficient and concentrated at one specific location, a large amount of the high current will pass through this contact area, causing concentration of resistance heat at this contact area. Under the circumstances, the contact surface of the contact cage can lead to melting due to overheat, resulting in electric disconnection or the damage of the terminal.

In order to solve the aforesaid problem, U.S. Pat. No. 6,062,919 discloses a contact cage structure. This contact cage has a number of flexible beams. After the contact cage is rolled up in a configuration of a hollow cylinder and positioned within a housing of a female terminal, the free ends of the flexible beams can surround and contact a male terminal, increasing the contact area for use in a high current product. However, the flexible beams of the contact cage can be permanently deformed or worn out after a large number of plugging and unplugging actions, causing some free ends of the flexible beams unable to contact the male terminal and shortening the service life of the product. Therefore, an improvement in this regard is required.

### SUMMARY OF THE INVENTION

The present invention has been accomplished under the circumstances in view. It is the main object of the present invention to provide a contact cage for use in a female terminal so that when a male terminal is inserted into a female terminal, the contact cage in the female terminal can provide a larger contact area for direction contact with the inserted male terminal, preventing melting of the contact area of the contact cage due to overheat and ensuring long durability.

To achieve this and other objects of the present invention, the invention provides a contact cage, which comprises a sheet member, a plurality of first elongated slots and a plurality of second elongated slots respectively linearly arranged on the sheet member, and a protruding portion respectively defined between each two adjacent first elongated slots and each two adjacent second elongated slots. Further, each protruding portion is bent to provide at least one end point. Thus, the contact cage can be rolled in a configuration of a hollow cylinder, keeping the end points of the protruding portions at an inner periphery surface of the hollow cylinder. These end points provide a larger contact area, and therefore the contact cage is practical for use in high current products. Further, because the protruding portions are securely connected to the sheet member, the contact cage is capable of sustaining a large number of plugging and unplugging actions, ensuring a long service life.

Preferably, the sheet member has a rectangular shape and the first elongated slots and the second elongated slots are respectively equispacedly arranged along one lateral side direction of the sheet member. Preferably, the number of the at least one end point of each protruding portion is 2. Thus, the invention is easy to fabricate and ensures high durability.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a plane view of a contact cage in an unrolled configuration in accordance with a first embodiment of the present invention.

FIG. 2 is a perspective view illustrating the contact cage rolled up in a configuration of a hollow cylinder.

FIG. 3 is an exploded view illustrating a contact cage mounted within a female terminal in accordance of the first embodiment of the present invention.

FIG. 4 is a cross-sectional side view of the contact cage installed within the female terminal in accordance with the first embodiment of the present invention.

FIG. 5 is a plane view of a contact cage in an unrolled configuration in accordance with a second embodiment of the present invention.

FIG. 6 is a plane view of a contact cage in an unrolled configuration in accordance with a third embodiment of the present invention.

### DETAILED DESCRIPTION OF THE INVENTION

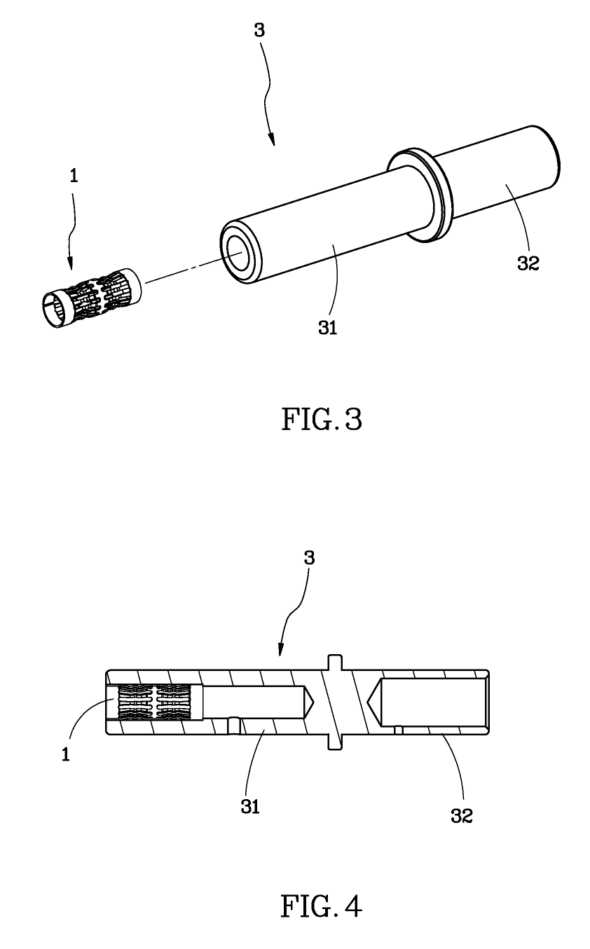

In order to better understand the features of the present invention, a first embodiment is set forth hereby with reference to the annexed drawings. Please refer to FIGS. 3 and FIGS. 4. A first embodiment of the present invention provides a female terminal 3 comprising a receptacle portion 31 and a connection portion 32, wherein a contact cage 1 is rolled up in a configuration of a hollow cylinder and abuts against an inner periphery surface of the receptacle portion 31 to surround and contact a corresponding male contact; the connection portion 32 is electrically connected to an electric wire for transmitting electric current from a power source such as a power generator or a battery. In this embodiment, the material of the contact cage 1 is copper.

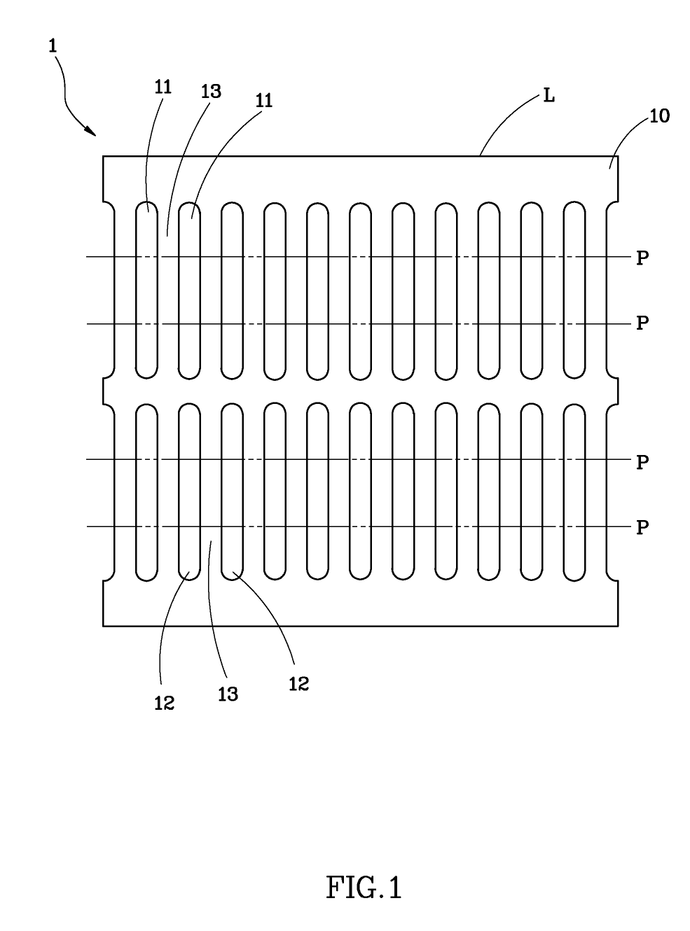

Referring to FIG. 1, the contact cage 1 comprises a sheet member 10 having a rectangular shape, and a plurality of first elongated slots 11 and second elongated slots 12 formed in the sheet member 10. In this embodiment, both of the number of the first elongated slots 11 and the number of the second elongated slots 12 are 12, wherein the first elongated slots 11 and the second elongated slots 12 are equispacedly and linearly arranged along a lateral side direction L of the sheet member 10 to constitute an arrangement of a rectangular array. Further, the sheet member 10 defines four virtual stamp lines P by which the part between each two adjacent first elongated slot 11 and the part between each two adjacent second elongated slot 12 are respectively mechanically stamped to form a respective protruding portion 13. Each protruding portion 13 has a wave-like shape, and at least one, for example, two end points 14 respectively located at one respective stamp line P. Alternatively, each protruding portion 13 can be configured having only one end point 14 located at one respective stamp line P.

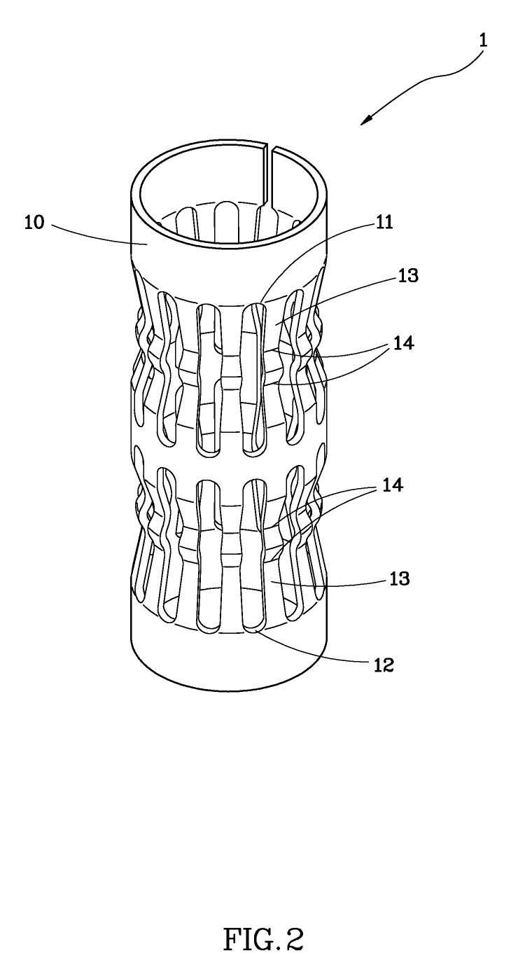

Referring to FIG. 2, the contact cage 1 can be rolled up along the lateral side direction L toward the protruding direction of the end points 14 to constitute a hollow cylinder and to keep the end points 14 at the inner surface of the hollow cylinder. Thereafter, the hollow cylinder is positioned concentrically within the receptacle portion 31 of the female terminal 3. When inserting a male terminal (not shown) into the female terminal 3, the end points 14 of the protruding portions 13 will be forced into direct contact with the male terminal. Therefore, the invention provides a larger contact area and is practical for use in high current products. Further, because the protruding portions 13 are formed integrally with the sheet member 10 and the two ends of each protruding portion 13 are securely connected to the sheet member 10, the contact cage 1 is capable of sustaining a large number of plugging and unplugging actions, ensuring a long service life.

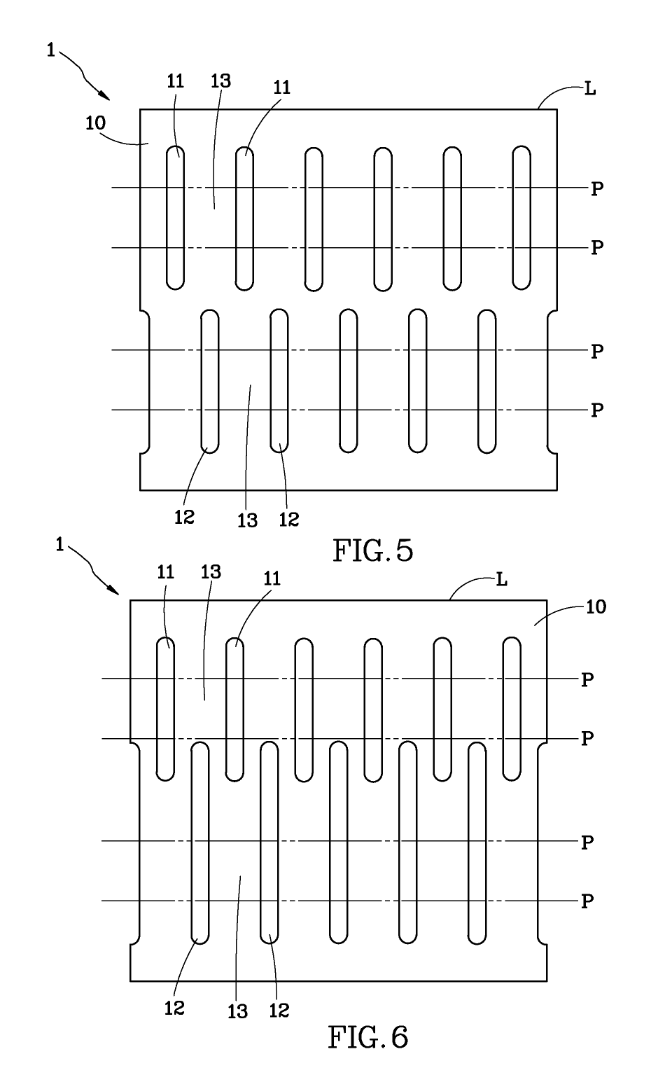

Any person skilled in the art can change the number of the end points of the protruding portions, the number of the elongated slots, or the arrangement of the elongated slots without departing from the spirit of the present invention. Referring to FIG. 5, a contact cage 1 in accordance with a second embodiment of the present invention is shown. The contact cage 1 of this second embodiment is substantially similar to the aforesaid first embodiment with the exception that: the first elongated slots 11 are offset from the second elongated slots 12 in a distance of one slot along the lateral side direction L of the sheet member 10 so that the protruding portions 13 are in a direction perpendicular to the side length direction L to respectively aimed at the first elongated slots 11 or the second elongated slots 12. Thus, the contact cage of this second embodiment keeps the end points 14 evenly distributed, enhancing the durability of the female terminal.

Referring to FIG. 6, a contact cage in accordance with a third embodiment of the present invention is shown. The structure of the contact cage 1 of this third embodiment is substantially similar to the aforesaid second embodiment with the exception that: the second elongated slots 12 respectively extend perpendicular to the side length direction L toward the protruding portions 13. Thus, the first elongated slots 11 and the second elongated slots 12 are alternately arranged, and the length of each second elongated slot 12 that extends perpendicular to the lateral side direction L is larger than the length of the first elongated slots 11, enabling each protruding portion 13 between two adjacent second elongated slots 12 to be stamped into three end points (at the locations where the respective stamp lines P pass).

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A contact cage, comprising a sheet member, a plurality of first elongated slots and a plurality of second elongated slots respectively linearly arranged on said sheet member, and a protruding portion respectively defined between each two adjacent said first elongated slots and each two adjacent said second elongated slots, each said protruding portion being bent to provide at least one end point, such that said contact cage can be rolled up in a configuration of a hollow cylinder and keep said end points at an inner periphery surface of said hollow cylinder.

2. The contact cage as claimed in claim 1, wherein said sheet member has a rectangular shape, and said first elongated slots and said second elongated slots are equispacedly arranged along a lateral side direction of said sheet member.

3. The contact cage as claimed in claim 2, wherein said contact cage is rolled up along said lateral side direction toward the protruding direction of said end points.

4. The contact cage as claimed in claim 2, wherein said first elongated slots are offset from said second elongated slots along said lateral side direction.

5. The contact cage as claimed in claim 4, wherein said second elongated slots respectively extend toward one respective said protruding portion.

6. The contact cage as claimed in claim 1, wherein the number of said at least one end point of each said protruding portion is 2.

7. The contact cage as claimed in claim 6, wherein the material of said contact cage is copper.

8. A female terminal, comprising a receptacle portion for receiving and contacting a male terminal, characterized in that a contact cage as claimed in claim 1 is installed within an inner periphery surface of said receptacle portion.
